(19) United States
(12) Patent Application Publication
(10) Pub. No.: US 2003/0225203 A1
(43) Pub. Date: Dec. 4, 2003

(54) Copolymer latex, process for producing copolymer latex, and paper coating composition

(75) Inventors: Osamu Kurita, Tokyo (JP); Fumihisa Miyajima, Tokyo (JP); Osamu Ishikawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: JSR CORPORATION, Tokyo (JP)

(21) Appl. No.: 10/156,110

(22) Filed: May 29, 2002

(51) Int. Cl. C08L 33/00

(52) U.S. Cl. 524/827; 524/832

(57) ABSTRACT

The present invention provides a copolymer latex capable of remarkably improving the bond strength of coated paper, excelling in coated paper properties such as print gloss, and excelling in coating operability such as redispersibility, mechanical stability, and anti-stick properties, a process for producing the copolymer latex, and a paper coating composition. In the copolymer latex of the present invention, the content of components detected before an elution time at which a component having a polystyrene-reduced molecular weight of 1,000,000 is detected in a molecular-weight distribution measured by gel permeation chromatography (GPC) is 31% or more, the weight average molecular weight of components detected after the elution time at which the component having a polystyrene-reduced molecular weight of 1,000,000 is detected is 30,000-400,000, and the toluene insoluble content is 31 wt % or more.

### BACKGROUND OF THE INVENTION

1. Field of the Invention

The present invention relates to a copolymer latex. More particularly, the present invention relates to a copolymer latex excelling in coated paper properties such as surface strength and print gloss, and in coating operability such as mechanical stability and anti-stick properties, to a process for producing the copolymer latex, and to a paper coating composition using the copolymer latex.

2. Description of Background Art

Conventionally, coated paper excelling in printability is produced by coating paper with a paper coating composition containing a pigment and a aqueous binder as main components. A copolymer latex excels in bonding strength and is used as a major binder of the paper coating composition.

Accompanied by recent development of high-quality and high-speed printing, performances required for coated paper have become more severe. Specifically, improvement of surface strength, water resistance, stiffness, ink transfer properties, print gloss, and the like has been demanded.

Since the production speed of coated paper has been increased, improvement of coating operability has been strongly demanded. Coating operability can be improved by decreasing the occurrence of aggregates or by improving roll-stain resistance (anti-stick properties).

In recent years, since a decrease in the amount of binder has been demanded in order to reduce costs, there has been a demand for a binder capable of exhibiting sufficient bonding strength with addition of only a small amount. In order to improve bonding strength of the copolymer latex, a method of controlling the gel content in the copolymer latex and a method of varying the composition of the copolymer have been proposed. However, since the surface strength may conflict with other properties, it is difficult to improve all the properties in good balance.

As a method for improving the bonding strength of the copolymer latex, a method of decreasing the glass transition temperature of the copolymer by increasing the amount of conjugated diene monomer used to produce the copolymer latex has been employed. However, it is difficult to improve anti-stick properties and mechanical stability of the latex using this method. Increasing the glass transition temperature ensures good mechanical stability, water resistance, and stiffness. However, it is difficult to maintain the surface strength and print gloss.

A method for improving the bonding strength of the copolymer latex by using a large amount of monomer having a functional group has been proposed. However, this method may cause a decrease in workability due to an increase in viscosity of the latex.

An object of the present invention is to provide a copolymer latex capable of remarkably improving the surface strength of coated paper, excelling in coated paper properties such as print gloss, and excelling in coating operability such as redispersibility, mechanical stability, and anti-stick properties, a process for producing the copolymer latex, and a paper coating composition using the copolymer latex.

### SUMMARY OF THE INVENTION

The present invention provides a copolymer latex produced by emulsion polymerization of (a) 10-80 parts by weight of a conjugated diene monomer, (b) 0.01-15 parts by weight of an ethylenically unsaturated carboxylic acid monomer, and (c) 5-89.99 parts by weight of other monomers copolymerizable with the conjugated diene monomer (a) and the ethylenically unsaturated carboxylic acid monomer (b), provided that the total amount of the components (a), (b), and (c) is 100 parts by weight, wherein, in a molecular weight distribution measured by gel permeation chromatography (GPC), components detected after an elution time at which a component having a polystyrene-reduced molecular weight of 1,000, 000 is detected have a weight average molecular weight of 30,000-400,000.

The component (c) preferably comprises a vinyl cyanide monomer. The vinyl cyanide monomer is used in an amount of usually 0.5-30 wt %, and preferably 1-25 wt %. Use of the vinyl cyanide monomer improves the cohesive force of the polymer, whereby the bonding strength is improved. Moreover, solvent resistance of the polymer is increased, whereby print gloss is improved.

In the copolymer latex of the present invention, the components detected after the elution time at which the component having a polystyrene-reduced molecular weight of 1,000,000 is detected in the molecular weight distribution measured by GPC have a weight average molecular weight of 30,000-400,000. Therefore, the molecular weight of the polymer is increased, whereby the cohesive force is improved. As a result, bonding strength is remarkably improved. In the copolymer latex of the present invention, the content of components detected before the elution time at which the component having a polystyrene-reduced molecular weight of 1,000,000 is detected (GPC measured gel content) is 31% or more. Therefore, the copolymer latex contains a large amount of cross-linked high-molecular-weight gel components having an increased molecular weight between the cross-linking points. This improves polymer strength and impact absorption, whereby the bonding strength is remarkably improved. Moreover, since the amount of low-molecular-weight component is small, coating operability such as mechanical stability and anti-stick properties is improved. Furthermore, since the copolymer latex of the present invention consists of low-cross-linked polymers, the copolymer latex has superior deformability at high temperature. Therefore, the copolymer latex can be used for a wide range of applications including web offset printing and sheet-fed offset printing by appropriately adjusting the toluene insoluble content or GPC measured gel content.

The copolymer latex of the present invention has a toluene insoluble content of 31% or more. Therefore, the copolymer latex excels in mechanical stability and anti-stick properties and has high solvent resistance, whereby good print gloss is obtained. The toluene insoluble content is preferably 51-95 wt %.

The GPC measured gel content in the copolymer latex of the present invention in the molecular-weight distribution measured by GPC is preferably 35-90%, and particularly preferably 51-90%. The weight average molecular weight of the components detected after the elution time at which the component having a polystyrene-reduced molecular weight of 1,000,000 is detected is preferably 40,000-200,000.

A process for producing a copolymer latex of the present invention comprises emulsion polymerizing (a) 10-80 parts by weight of a conjugated diene monomer, (b) 0.01-15 parts by weight of an ethylenically unsaturated carboxylic acid monomer, and (c) 5-89.99 parts by weight of other monomers copolymerizable with the conjugated diene monomer (a) and the ethylenically unsaturated carboxylic acid monomer (b), provided that the total amount of the components (a), (b), and (c) is 100 parts by weight, in the presence of a polymerization initiator comprising a radical catalyst and a reducing agent. The copolymer latex obtained by emulsion polymerization in the presence of the radical catalyst and the reducing agent excels in dispersion stability during the preparation of a paper coating composition, exhibits improved bonding strength, and excels in coating operability such as redispersibility, anti-stick properties, and mechanical stability.

A process for producing the copolymer latex according to another embodiment of the present invention comprises:

emulsion polymerizing 5-80 parts by weight of (A) a monomer component comprising (a) 20-99 wt % of a conjugated diene monomer, (b) 0-10 wt % of an ethylenically unsaturated carboxylic acid monomer, and (c) 0-80 wt % of other copolymerizable monomers to prepare a polymer (P) having a glass transition temperature (Tg) of 0° C. or less, and

emulsion polymerizing 20-95 parts by weight of (B) a monomer component comprising (a) 0-80 wt % of a conjugated diene monomer, (b) 0.01-20 wt % of an ethylenically unsaturated carboxylic acid monomer, and (c) 0-99.99 wt % of other copolymerizable monomers, provided that the total amount of the monomer components (A) and (B) is 100 parts by weight, in the presence of the polymer (P) and a polymerization initiator comprising a radical catalyst and a reducing agent,

wherein at least part of the reducing agent is added intermittently and/or continuously at least during the polymerization step of the monomer component (B),

wherein the total amount of the conjugated diene monomer (a), ethylenically unsaturated carboxylic acid monomer (b), and other copolymerizable monomers (c) in the monomer components (A) and (B) is 10-80 wt %, 0.01-15 wt %, and 5-89.99 wt %, respectively.

According to the process for producing a copolymer latex of the present invention, a copolymer latex capable of remarkably improving the surface strength of coated paper, excelling in coated paper properties such as print gloss, and excelling in coating operability such as redispersibility, mechanical stability, and anti-stick properties can be obtained.

The component (c) in the monomer component (A) preferably comprises a vinyl cyanide monomer. The amount of the vinyl cyanide monomer in the monomer component (A) is usually 0.1-50 wt %, preferably 0.5-45 wt %, and still more preferably 1-40 wt %.

The component (c) in the monomer component (B) preferably comprises a vinyl cyanide monomer. The amount of the vinyl cyanide monomer in the monomer component (B) is usually 0.1-30 wt %, preferably 0.5-28 wt %, and still more preferably 1-25 wt %.

Mechanical and chemical stability of the copolymer latex is improved by adding at least part of the reducing agent intermittently, continuously, or combining these methods during the reaction step of the monomers, whereby the above-described effects can be obtained.

Since the polymer (P) has a glass transition temperature of 0° C. or less, the objective performance is further improved by allowing a copolymer having a low glass transition temperature to present in the single latex particle to provide a hetero-phase structure. Specifically, since this copolymer latex has a copolymer having a low glass transition temperature in the latex particles, the copolymer latex has high resistance to impact deformation at an extremely high deformation rate during high-speed printing, for example. As a result, the copolymer latex has high bonding strength. Moreover, since the copolymer latex also has a copolymer having a high glass transition temperature in the single particle, other properties such as water resistance and stiffness can be maintained at a high level. In addition, the copolymer latex exhibits excellent coating operability due to improved anti-stick properties.

A paper coating composition of the present invention comprises the copolymer latex of the present invention and a pigment as essential components. Since the paper coating composition excels in surface strength and has other good coated paper characteristics such as water resistance, the paper coating composition is suitably used for various types of printing paper, in particular, for offset printing paper and gravure printing paper.

In the paper coating composition of the present invention, in the case of using hollow polymers as the pigment, hollow polymer particles are used as at least apart of the pigments. The hollow polymer particles used herein refer to polymer particles having a void inside the polymer layer. Since the hollow polymer particles have a void therein, the hollow polymer particles are lightweight in comparison with conventionally used pigments such as titanium oxide. Therefore, the weight of the coated paper can be decreased by using the hollow polymer particles as at least a part of the pigments.

### BRIEF DESCRIPTION OF THE DRAWING

FIG. 1 is a view showing an elution curve obtained by GPC measurement, in which the vertical axis indicates a detected amount and the horizontal axis indicates the elution time.

### DETAILED DESCRIPTION OF THE EMBODIMENT

A copolymer latex, a process for producing the copolymer latex, and a paper coating composition using the copolymer latex of the present invention are described below in detail.

(Copolymer Latex)

(Monomer Composition)

A conjugated diene monomer (a) used in the production of the copolymer latex provides moderate flexibility and elongation to the resulting polymer, thereby providing impact resistance.

As specific examples of the conjugated diene monomer (a), 1,3-butadiene, isoprene, 2,3-dimethyl-1,3-butadiene, 2-ethyl-1,3-butadiene, 2-methyl-1,3-butadiene, 1,3-pentadiene, chloroprene, 2-chloro-1,3-butadiene, cyclopentadiene, and the like can be given. These compounds may be used either individually or in combination of two or more. Of these compounds, butadiene is particularly preferable.

The conjugated diene monomer (a) is used in an amount of 10-80 parts by weight, and preferably 20-75 parts by weight of 100 parts by weight of the total amount of the monomers. If the amount is less than 10 parts by weight, sufficient bond strength may not be obtained. If the amount exceeds 80 parts by weight, water resistance and surface strength may be decreased.

As specific examples of an ethylenically unsaturated carboxylic acid monomer (b) used to produce the copolymer latex, or compounds converted into the ethylenically unsaturated carboxylic acid monomer (b) during emulsion polymerization using an aqueous medium, the following compounds can be given:

(i) monocarboxylic acids such as acrylic acid, methacrylic acid, and crotonic acid;

(ii) dicarboxylic acids such as maleic acid, fumaric acid, and itaconic acid;

(iii) half esters such as methyl maleate, methyl itaconate, and β-methacryloxyethyl acid hexahydrophthalate;

(iv) anhydrides of the above unsaturated carboxylic acids (i) and (ii) such as acrylic anhydride and maleic anhydride, which can be used as monomers during emulsion polymerization because these compounds are converted into carboxylic acids during emulsion polymerization in an aqueous medium; and

(v) potassium salts, sodium salts, and ammonium salts of the above compounds (i) to (iv).

These compounds may be used either individually or in combination of two or more.

Of these compounds, at least one compound selected from the group consisting of the monocarboxylic acids (i), dicarboxylic acids (ii), half esters (iii), and dicarboxylic anhydrides (iv) is preferably used as the ethylenically unsaturated carboxylic acid monomer (b).

The ethylenically unsaturated carboxylic acid monomer (b) is used in an amount of 0.01-15 parts by weight, and preferably 0.05-10 parts by weight of 100 parts by weight of the total amount of the monomers. If the amount of the ethylenically unsaturated carboxylic acid monomer (b) is less than 0.01 part by weight, bonding strength and mechanical/chemical stability of the copolymer latex may be decreased. If the amount of the ethylenically unsaturated carboxylic acid monomer (b) exceeds 15 parts by weight, handling of the resulting latex may become difficult due to an increased viscosity. This hinders workability, whereby practicability is decreased.

As other monomers (c) copolymerizable with the conjugated diene monomer (a) and the ethylenically unsaturated carboxylic acid monomer (b) (hereinafter maybe called “other monomers (c)”), compounds having one or more polymerizable unsaturated bonds in the molecule are preferably used. However, compounds corresponding to the ethylenically unsaturated carboxylic acid monomers are excluded.

As examples of other monomers (c), (i) aromatic vinyl compounds, (ii) acrylates and methacrylates, (iii) unsaturated dibasic acid alkyl esters, (iv) vinyl cyanide compounds, (v) acrylamides and methacrylamides, (vi) vinyl esters, (vii) vinyl ethers, (viii) vinyl halides, (ix) basic monomers having an amino group, (x) vinylpyridines, (xi) olefins, (xii) silicon-containing α,β-ethylenically unsaturated monomers, (xiii) allyl compounds, and the like can be given. These compounds may be used either individually or in combination of two or more.

As examples of the aromatic vinyl compounds (i), styrene, α-methylstyrene, o-methylstyrene, m-methylstyrene, p-methylstyrene, ethylstyrene, vinyltoluene, vinylxylene, bromostyrene, vinylbenzyl chloride, p-t-butylstyrene, chlorostyrene, alkylstyrene, divinylbenzene, trivinylbenzene, and the like can be given. Of these, styrene and a-methylstyrene are preferable.

As examples of the acrylates and methacrylates (ii), methyl (meth)acrylate, ethyl (meth)acrylate, propyl (meth)acrylate, n-butyl (meth)acrylate, t-butyl (meth)acrylate, isobutyl (meth)acrylate, n-amyl (meth)acrylate, isoamylhexyl (meth)acrylate, octyl (meth)acrylate, nonyl (meth)acrylate, decyl (meth)acrylate, dodecyl (meth)acrylate, octadecyl (meth)acrylate, cyclohexyl (meth)acrylate, phenyl (meth)acrylate, benzyl (meth)acrylate, 2-ethylhexyl (meth)acrylate, hydroxyethyl (meth)acrylate, hydroxypropyl (meth)acrylate, hydroxycyclohexyl (meth)acrylate, glycidyl (meth) acrylate, ethylene glycol di (meth) acrylate, 1,3-butylene glycoldi (meth) acrylate, 1,4-butyleneglycoldi (meth) acrylate, propylene glycol di(meth)acrylate, 1,5-pentanediol di(meth)acrylate, neopentyl glycol di(meth)acrylate, 1,6-hexanediol di(meth)acrylate, diethylene glycol di(meth)acrylate, triethylene glycol di(meth)acrylate, tetraethylene glycol di(meth)acrylate, polyethylene glycol di(meth)acrylate, polypropylene glycol di(meth)acrylate, pentaerythritol tri(meth)acrylate, trimethylolpropane tri (meth) acrylate, tetramethylolmethane tetra (meth) acrylate, allyl (meth)acrylate, bis(4-acryloxypolyethoxyphenyl) propane, methoxypolyethylene glycol (meth)acrylate, β-(meth)acryloyloxyethyl hydrogen phtalate, β-(meth)acryloyloxyethyl hydrogen succinate, 3-chloro-2-hydroxypropyl (meth)acrylate, stearyl (meth)acrylate, phenoxyethyl (meth)acrylate, phenoxypolyethylene glycol (meth)acrylate, 2-hydroxy-1,3-di(meth)acryloxypropane, 2,2-bis[4-((meth)acryloxyethoxy)phenyl]propane, 2,2-bis[4-((meth)acryloxydiethoxy)phenyl]propane, 2,2-bis[4-((meth)acryloxypolyethoxy)phenyl]propane, isobornyl (meth)acrylate, and the like can be given.

As examples of the unsaturated dibasic acid alkyl esters (iii), alkyl crotonate, alkyl itaconate, alkyl fumarate, alkyl maleate, and the like can be given.

As examples of the vinyl cyanide compounds (iv), acrylonitrile, methacrylonitrile, and the like can be given.

As examples of the acrylamides and methacrylamides (v), (meth)acrylamide, N-methylol(meth)acrylamide, N-alkoxy(meth)acrylamide, and the like can be given.

As examples of the vinyl esters (vi), vinyl acetate, vinyl butyrate, vinyl stearate, vinyl laurate, vinyl myristate, vinyl propionate, vinyl versatate, and the like can be given.

As examples of the vinyl ethers (vii), methyl vinyl ether, ethyl vinyl ether, propyl vinyl ether, butyl vinyl ether, amyl vinyl ether, hexyl vinyl ether, and the like can be given.

As examples of the vinyl halides (viii), vinyl chloride, vinyl bromide, vinyl fluoride, vinylidene chloride, vinylidene fluoride, and the like can be given.

As examples of the basic monomers (ix) having an amino group, aminoethyl (meth) acrylate, dimethylaminoethyl (meth) acrylate, diethylaminoethyl (meth)acrylate, and the like can be given.

As examples of the olefins (xi), ethylene and the like can be given.

As examples of the silicon-containing α,β-ethylenically unsaturated monomers (xii), vinyltrichlorosilane, vinyltriethoxysilane, and the like can be given.

As examples of the allyl compounds (xiii), allyl ester, diallyl phthalate, and the like can be given.

These monomers may be used either individually or in combination of two or more.

Other monomers (c) are used to provide moderate hardness, elasticity, and water resistance to the resulting copolymer. Other monomers (c) are used in an amount of 5-89.99 parts by weight, and preferably 15-79.95 parts by weight of 100 parts by weight of the total amount of the monomers. If the amount of other monomers (c) is less than 5 parts by weight, water resistance may be insufficient. If the amount of other monomers (c) exceeds 89.99 parts by weight, hardness of the copolymer is increased excessively, whereby the surface strength may be decreased.

(GPC Measured Gel Content and Weight Average Molecular Weight of Components Detected After Elution Time at Which Component Having Polystyrene-Reduced Molecular Weight of 1,000,000 is Detected)

The copolymer latex of the present invention includes components detected before the elution time at which a component having a polystyrene-reduced molecular weight of 1,000,000 is detected in the molecular-weight distribution measured by gel permeation chromatography (GPC) in an amount of 31% or more, preferably 35-90%, and particularly preferably 51-90%. In the present invention, the components detected before the elution time at which the component having a polystyrene-reduced molecular weight of 1,000,000 is detected are referred to as a GPC measured gel. If the GPC measured gel content is less than 31%, good bond strength may not be obtained.

The GPC measured gel content in the copolymer latex of the present invention may be adjusted to 31% or more by controlling the polymerization temperature, amount of molecular-weight modifier, method of adding the monomers, amount and type of polymerization initiator, and the like.

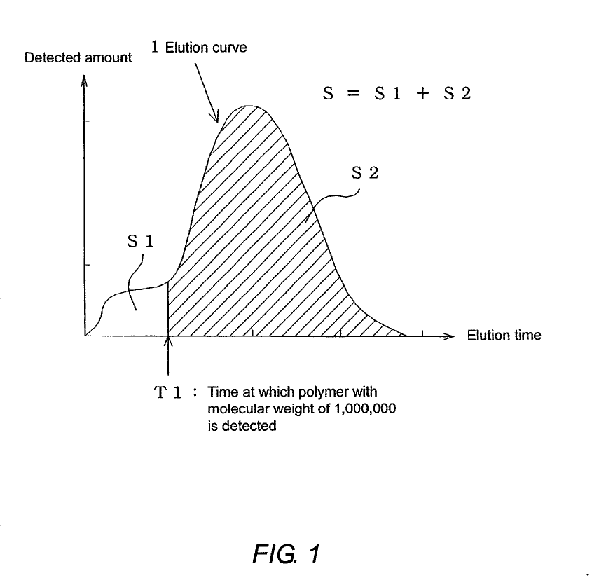

As shown in FIG. 1, in an elution curve 1 in which the vertical axis indicates the detected amount and the horizontal axis indicates the elution time, provided that the area enclosed by the elution curve 1 and the horizontal axis is S (S=S1+S2), the components detected before the elution time at which the component having a polystyrene-reduced molecular weight of 1,000,000 is detected in the molecular-weight distribution measured by GPC refer to components (S1) eluted before an elution time T1 at which a polymer having a polystyrene-reduced molecular weight of 1,000,000 is detected. The components detected after the elution time at which the component having a polystyrene-reduced molecular weight of 1,000,000 is detected refer to components (S2) eluted after the elution time T1 shown in FIG. 1 at which the polymer having a polystyrene-reduced molecular weight of 1,000,000 is detected.

The GPC measured gel content (%) is determined using the following equation.

GPC measured gel content (%)=S1/(S1+S2)×100

The weight average molecular weight of the components detected after the elution time at which the component having a polystyrene-reduced molecular weight of 1,000,000 is detected in the molecular-weight distribution measured by GPC is 30,000-400,000, and preferably 40,000-200,000. If the weight average molecular weight of the components eluted during this period is less than 30,000, good bonding strength may not be obtained. If the weight average molecular weight of such components exceeds 400,000, handling of the resulting latex may become difficult due to an increased viscosity although good bonding strength is obtained. This hinders workability, whereby practicability is decreased.

The weight average molecular weight of the components detected after the elution time at which the component having a polystyrene-reduced molecular weight of 1,000,000 is detected refers to a polystyrene-reduced value determined by gel permeation chromatography. The weight average molecular weight of such components may be controlled by the polymerization temperature and the polymerization formulations such as the amount and type of molecular-weight modifier and polymerization initiator.

In the present invention, GPC is measured under the following conditions, for example.

(Preparation of Sample)

1 g of water and 1 g of a cation exchange resin which is washed with water according to a conventional method are added to 0.3 g of the copolymer latex of which the solid content is adjusted to 48 wt % to remove cations. After the addition of 50 ml of tetrahydrofuran, the mixture is allowed to stand for two hours, thereby causing the copolymer latex to be dissolved. The mixture is filtered through a membrane filter made of polytetrafluoroethylene (pore size: 3 μm, manufactured by Advantec, Co., Ltd.). The filtrate is used as a measurement sample.

(Measurement System and Conditions)

Measurement system: HLC-8020 (manufactured by Tosoh Corp.)

Type and particle diameter of packing material: polystyrene gel with particle diameter of 30 μm

GMH HR-H (30) (manufactured by Tosoh Corp.)

Column size: 7.8 mm×300 mm

Solvent: tetrahydrofuran

Concentration of sample: 0.3 wt %

Injection amount: 30 μl

Flow rate: 1 ml/min.

Temperature: 40° C.

Detector: differential refractometer

A calibration curve is previously created before the measurement by using a polystyrene standard substance with a known molecular weight and indicated as a polystyrene-reduced molecular weight.

(Toluene Insoluble Content)

The copolymer latex of the present invention has a toluene insoluble content of 31 wt % or more, and preferably 51-95 wt %. If the toluene insoluble content is less than 31 wt %, bonding strength, mechanical stability, and anti-stick properties may be decreased.

The toluene insoluble content of the copolymer latex of the present invention is measured as follows.

The copolymer latex is adjusted to 8.0 pH and coagulated with isopropanol. The resulting solid content is washed and dried with methanol. About 0.3 g of this solid content (entire solid content A) is immersed in 100 ml of toluene at room temperature for 20 hours, and filtered using a No. 2 qualitative filter paper. Part of the filtrate (C ml) is collected precisely and coagulated by evaporation. The residual solid content (toluene soluble content B) is weighed to determine the toluene insoluble content using the following equation.

Toluene insoluble content (%)={(A−B×(100/C))/A}×100(%)

The toluene insoluble content may be controlled by the polymerization temperature, amount and type of the molecular-weight modifier, method of adding the monomers, and the like.

(Process for Producing Copolymer Latex)

The copolymer latex of the present invention is produced by the emulsion polymerization of the monomer components (a) to (c). As a method of polymerizing the monomers, a method of polymerizing part of the monomer components in advance, and adding and polymerizing the remaining monomers can be given. The monomers may be added to the polymerization system all at once, intermittently, or continuously. These methods may be used in combination. Intermittent addition means adding the monomers separately at a plurality of times. Continuous addition means continuously adding a specific amount of monomers during a specific period of time.

In this case, the emulsion polymerization may be carried out in the presence of a radical catalyst and a reducing agent, as described above. This enables the above-described effects to be increased. Still more preferably, in the emulsion polymerization using the radical catalyst and the reducing agent, at least part of the reducing agent is added during the monomer reaction step either intermittently or continuously, or by combining these methods.

The polymerization temperature is preferably 5-80° C., still more preferably 20-70° C., and particularly preferably 20-60° C. The copolymer latex obtained in this temperature range exhibits well-balanced dry pick resistance and anti-stick properties as a paper coating binder.

The process for producing the copolymer latex according to another embodiment of the present invention comprises emulsion polymerizing 5-80 parts by weight of (A) a monomer component comprising (a) 20-99 wt % of a conjugated diene monomer, (b) 0-10 wt % of an ethylenically unsaturated carboxylic acid monomer, and (c) 0-80 wt % of other copolymerizable monomers to prepare a polymer (P) having a glass transition temperature (Tg) of 0° C. or less, and emulsion polymerizing 20-95 parts by weight of (B) a monomer component comprising (a) 0-80 wt % of a conjugated diene monomer, (b) 0.01-20 wt % of an ethylenically unsaturated carboxylic acid monomer, and (c) 0-99.99 wt % of other copolymerizable monomers, provided that the total amount of the monomer components (A) and (B) is 100 parts by weight, in the presence of the polymer (P) and a polymerization initiator comprising a radical catalyst and a reducing agent, wherein at least part of the reducing agent is added intermittently or continuously at least during the polymerization step of the monomer component (B).

The total amount of the monomers in the monomer component (A) and the monomer component (B) satisfies the following conditions.

(a) Conjugated diene monomer: 10-80 wt %

(b) Ethylenically unsaturated carboxylic acid monomer: 0.01-15 wt %

(c) Other copolymerizable monomers: 5-89.99 wt %

The polymer (P) is used in an amount of 5-90 parts by weight, and preferably 10-90 parts by weight of the total amount of the copolymer. If the amount of the polymer (P) is less than 5 parts by weight, impact resistance and bonding strength may be insufficient. If the amount exceeds 90 parts by weight, components having a relatively low glass transition temperature may be increased excessively, whereby anti-stick properties are significantly decreased.

The glass transition temperature of the polymer (P) is preferably 0° C. or less, still more preferably −5° C. or less, and particularly preferably from −10 to −60° C. If the glass transition temperature is more than 0° C., the copolymer becomes hard, whereby sufficient bonding strength may not be obtained.

In this case, the polymerization temperature in a reaction vessel is preferably 5-60° C., still more preferably 20-60° C., and particularly preferably 30-60° C.

The amount of the conjugated diene monomer (a) in the monomer component (A) is usually 20-99 wt %, preferably 30-95 wt %, and still more preferably 35-90 wt %. The amount of the ethylenically unsaturated carboxylic acid monomer (b) in the monomer component (A) is usually 0-10 wt %, preferably 0-5 wt %, and still more preferably 0-4 wt %. The amount of other copolymerizable monomers (c) in the monomer component (A) is usually 0-80 wt %, preferably 0-70 wt %, and still more preferably 0-65 wt %.

The amount of the conjugated diene monomer (a) in the monomer component (B) is usually 0-80 wt %, preferably 0-70 wt %, and still more preferably 0-60 wt %. The amount of the ethylenically unsaturated carboxylic acid monomer (b) in the monomer component (B) is usually 0.01-20 wt %, preferably 0.5-15 wt %, and still more preferably 1-10 wt %. The amount of other copolymerizable monomers (c) in the monomer component (B) is usually 0-99.99 wt %, preferably 0-99.5 wt %, and still more preferably 0-99 wt %.

The component (c) in the monomer component (A) preferably comprises a vinyl cyanide monomer. The amount of the vinyl cyanide monomer in the monomer component (A) is usually 0.1-50 wt %, preferably 0.5-45 wt %, and still more preferably 1-40 wt %.

The component (c) in the monomer component (B) preferably comprises a vinyl cyanide monomer. The amount of the vinyl cyanide monomer in the monomer component (B) is usually 0.1-30 wt %, preferably 0.5-28 wt %, and still more preferably 1-25 wt %.

As a method for preparing the polymer (P), a conventional emulsion polymerization method may be employed. For example, a method of polymerizing the monomer component (A) all at once, a method of polymerizing part of the monomer component (A), and adding the remaining portion of the monomer component (A) either continuously or intermittently, a method of continuously adding the monomer component (A) from the beginning of polymerization, or the like may be employed.

As a method of polymerizing the polymer (P) and the monomer component (B), the copolymer latex may be obtained by preparing the polymer (P) by polymerization and polymerizing the monomer component (B) in the presence of the polymer (P) in the same polymerization system, or polymerizing the monomer component (B) in the presence of the polymer (P) prepared by polymerizing the monomer component (A) in another polymerization vessel.

In the case of polymerizing the monomer component (B) by adding the monomer component (B) to a system containing the polymer (P), the monomer component (B) may be added to the polymerization system all at once, intermittently, or continuously. These methods may be used in combination. intermittent addition means adding the monomers separately at a plurality of times. Continuous addition means continuously adding a specific amount of monomers during a specific period of time. The addition of the monomer component (B) either intermittently or continuously to the polymerization system prevents a sudden increase in temperature of the polymerization system due to reaction heat generated by rapid progress of the reaction.

In the copolymer component of the copolymer latex to be produced, the weight average molecular weight of the components detected after the elution time at which the component having a polystyrene-reduced molecular weight of 1,000,000 is detected in the molecular-weight distribution measured by GPC is preferably 30,000-400,000. If the molecular weight of the copolymer component is within the above range, the above-described effects can be obtained.

A polymerization initiator, emulsifier, molecular-weight modifier, and the like used during emulsion polymerization, the polymerization conditions, and the like in the process for producing the copolymer latex of the present invention are described below.

(Polymerization Initiator)

A radical catalyst radically decomposes in the presence of heat or reducing substances to initiate addition polymerization of the monomers. As the radical catalyst, inorganic catalysts represented by persulfates such as sodium persulfate, potassium persulfate, and ammonium persulfate, and organic catalysts represented by hydroperoxides such as cumene hydroperoxide, diisopropylbenzene hydroperoxide, and paramenthane hydroperoxide may be used.

As examples of a reducing agent, erythorbic acid, sodium erythorbate, potassium erythorbate, ascorbic acid, sodium ascorbate, potassium ascorbate, saccharide, Rongalite (sodium formaldehyde sulfoxylate), sulfite such as sodium hydrogensulfite, potassium hydrogensulfite, sodium sulfite, and potassium sulfite, pyrosulfite such as sodium hydrogen pyrosulfite, potassium hydrogen pyrosulfite, sodium pyrosulfite, and potassium pyrosulfite, sodium thiosulfate, potassium thiosulfate, phosphorous acid, phosphite such as sodium phosphite, potassium phosphite, sodium hydrogenphosphite, and potassium hydrogenphosphite, pyrophosphorous acid, pyrophosphite such as sodium pyrophosphite, potassium pyrophosphite, sodium hydrogen pyrophosphite, and potassium hydrogen pyrophosphite, mercaptan, and the like can be given. The reducing agent is preferably used in an amount of 0.01-10 parts by weight for 100 parts by weight of the monomers.

As specific examples of a method of adding the radical catalyst and the reducing agent, a method of continuously adding the radical catalyst and the reducing agent at the same time to the polymerization reactor from separate supply pipes, a method of continuously adding the reducing agent to a polymerization system in which the radical catalyst is present excessively in comparison with the reducing agent, and a method of continuously adding the polymerization initiator to a polymerization system in which the reducing agent is present excessively in comparison with the radical catalyst can be given. The equivalent ratio of the radical catalyst to the reducing agent is preferably from 100/1 to 1/100.

The emulsion polymerization may be carried out by adding an oxidation-reduction catalyst to the polymerization system in addition to the radical catalyst and the reducing agent. As examples of the oxidation-reduction catalyst, metal catalysts such as divalent iron ions, trivalent iron ions, and copper ions can be given. The oxidation-reduction catalyst may be added to the polymerization system either batchwise or continuously, or by combining these in the same manner as in the case of the reducing agent. As a preferable combination of the radical catalyst, reducing agent, and oxidation-reduction catalyst, a combination of potassium persulfate as the radical catalyst, sodium hydrogensulfite as the reducing agent, and ferrous sulfate as the oxidation-reduction catalyst can be given.

(Emulsifier)

As the emulsifiers, anionic surfactants, nonionic surfactants, amphoteric surfactants, and the like may be used either individually or in combination of two or more.

As examples of anionic surfactants, sulfates of higher alcohols, alkylbenzene sulfonates, aliphatic sulfonates, sulfates of polyethylene glycol alkyl ether, alkyl diphenyl ether disulfonates, and the like can be given.

As examples of nonionic surfactants, conventional alkyl esters, alkyl ethers, and alkyl phenyl ethers of polyethylene glycol, and the like can be given.

As examples of ampholytic surfactants, compounds containing carboxylate, sulfate, sulfonate, or phosphate as an anion portion and amine salt or quaternary ammonium salt as a cation portion can be given. Specific examples include betaines such as lauryl betaine and stearyl betaine, amino acid type compounds such as lauryl-β-alanine, stearyl-β-alanine, lauryl di(aminoethyl)glycine, and octyl di(aminoethyl)glycine, and the like.

Of these emulsifiers, an alkylbenzene sulfonate is preferably used. Use of sodium dodecylbenzenesulfonate is still more preferable.

The emulsifier is used in an amount of preferably 0.05-2 parts by weight, and still more preferably 0.05-1 part by weight for 100 parts by weight of the total monomers. If the amount of emulsifier exceeds 2 parts by weight, water resistance may be decreased and the paper coating composition exhibits significant foaming. This causes a problem when applying the paper coating composition.

The emulsifier is preferably added to the polymerization system either batchwise or continuously, or by combining these methods.

(Molecular-Weight Modifier)

There are no specific limitations to the molecular-weight modifier used for emulsion polymerization in the production process of the copolymer latex of the present invention. Specific examples include mercaptans such as n-hexylmercaptan, n-octylmercaptan, n-dodecylmercaptan, t-dodecylmercaptan, n-hexadecylmercaptan, n-tetradecylmercaptan, t-tetradecylmercaptan, and thioglycolic acid, xanthogen disulfides such as dimethyl xanthogen disulfide, diethyl xanthogen disulfide, and diisopropyl xanthogen disulfide, thiuram sulfides such as tetramethyl thiuram disulfide, tetraethyl thiuram disulfide, and tetrabutyl thiuram disulfide, halogenated hydrocarbons such as chloroform, carbon tetrachloride, carbon tetrabromide, and ethylene bromide, hydrocarbons such as pentaphenylethane and α-methylstyrene dimer, acrolein, methacrolein, allyl alcohol, 2-ethylhexylthioglycolate, terpinolene, α-terpinene, γ-terpinene, dipentene, 1,1-diphenylethylene, and the like. These compounds maybe used either individually or in combination of two or more. Of these compounds, mercaptans, xanthogen disulfides, thiuram disulfides, 1,1-diphenylethylene, and α-methylstyrene dimer are preferably used.

The molecular-weight modifier is used in an amount of preferably 0-20 parts by weight, still more preferably 0.05-15 parts by weight, and particularly preferably 0.1-10 parts by weight for 100 parts by weight of the total monomers. If the amount of molecular-weight modifier exceeds 20 parts by weight for 100 parts by weight of the total monomers, bond strength may be decreased.

The molecular-weight modifier may be added to the polymerization system all at once, batchwise, continuously, or combination of these methods.

In the present invention, various types of polymerization modifier may optionally be added. For example, pH adjustor, chelating agents, and the like may be used.

As examples of pH adjustor, sodium hydroxide, potassium hydroxide, ammonium hydroxide, sodium hydrogencarbonate, sodium carbonate, disodium hydrogenphosphate, and the like can be given. Of these, sodium hydroxide, potassium hydroxide, or ammonium hydroxide are preferably used as the pH adjustor after polymerization. As examples of chelating agents, sodium ethylenediamine tetraacetate, and the like can be given.

(Paper Coating Composition)

The copolymer latex of the present invention is suitably used for a paper coating composition.

The paper coating composition using the copolymer latex of the present invention is utilized by combining the copolymer latex, optional other binders, and various types of compounding agent such as water-soluble polymers and additives with an inorganic or organic pigment. The amount (solid content) of the copolymer latex to be used is preferably 0.5-100 parts by weight, still more preferably 1-100 parts by weight, and particularly preferably 1-30 parts by weight for 100 parts by weight of the pigment. If the amount of the copolymer latex is less than 0.5 part by weight, bond strength maybe decreased. If the amount exceeds 100 parts by weight, ink drying properties may be decreased.

As the inorganic pigments, kaolin clay, barium sulfate, titanium oxide, calcium carbonate, satin white, talc, aluminum hydroxide, zinc oxide, and the like may be used. As the organic pigments, a polystyrene latex, urea formalin resin, and the like may be used. These pigments may be used either individually or in combination of two or more.

Hollow polymer particles may be used as in least a part of the pigments. The hollow polymer particles used herein refer to polymer particles having a void inside the polymer layer.

The average particle diameter of the hollow polymer particles is preferably 50-10,000 nm. The void volume ratio of the hollow polymer particles is preferably 20-80%. The polymer component of the hollow polymer particles is preferably produced by polymerization of monomers selected from the above monomers (a), (b), and (c). The polymer component is particularly preferably produced by polymerization of monomers including at least one of the aromatic vinyl compound, acrylate, and methacrylate. The polymer component of the hollow polymer particles may have a crosslinked structure. The Tg of the hollow polymer particles is preferably 25° C. or more.

As other binders, natural binders such as starch, starch oxide, soybean protein, and casein, and synthetic latexes such as a polyvinyl alcohol, polyvinyl acetate latex, and acrylic latex may be used.

Various types of generally used compounding agents may optionally be added to the paper coating composition of the present invention. As examples of such compounding agents, dispersants such as sodium pyrophosphate and sodium hexametaphosphate, deformer such as polyglycol, fatty acid ester, phosphate, and silicone oil, leveling agents such as Turkey red oil, dicyanamide, and urea, preservative, insolubilizer such as formalin, hexamine, melamine resin, urea resin, and glyoxal, lubricant such as calcium stearate and paraffin emulsion, fluorescent dyes, color retention improvers such as carboxymethylcellulose and sodium alginate, and the like can be given.

The paper coating composition using the copolymer latex of the present invention, in particular, the paper coating composition for offset printing paper may optionally comprise water-soluble materials such as casein, modified casein, starch, modified starch, polyvinyl alcohol, and carboxymethylcellulose in combination as pigment binder in addition to the copolymer latex.

The paper coating composition using the copolymer latex of the present invention may optionally comprise various types of commonly used additives such as water resistance improvers, pigment dispersants, viscosity modifier, coloring pigments, fluorescent dyes, and pH adjustor.

The copolymer latex of the present invention is suitably used as a binder for offset or gravure printing paper. The copolymer latex can be used for applications other than offset or gravure printing paper such as a binder for various types of printing paper such as letterpress printing paper and as a paper coating material.

The paper coating composition using the copolymer latex of the present invention is applied to base stock by using a conventional method utilizing an air knife coater, blade coater, roll coater, or applicator.

### EXAMPLES

The present invention is described below in detail by examples, which should not be construed as limiting the present invention. In the examples, “%” and “parts” respectively refer to “wt %” and “parts by weight” unless otherwise indicated.

### Examples 1-2

(Production Process of Copolymer Latex)

A high-pressure reaction vessel equipped with a stirrer and thermostat was charged with a first-stage component shown in Table 1. After replacing the atmosphere of the polymerization system with nitrogen, the monomers were polymerized at 40° C. for two hours. A second-stage component shown in Table 1 and half of a reducing agent aqueous solution were continuously added to the polymerization system for five hours. The remaining half of the reducing agent aqueous solution was continuously added for five hours to complete the polymerization. The final polymer conversion rate was 98%.

The resulting copolymer latex was adjusted to 7.5 pH using sodium hydroxide. After removing the unreacted monomers by blowing steam, the mixture was subjected to steam distillation while heating to obtain a copolymer latex with a solid content of 50%.

The content (%) of a component detected before the elution time corresponding to the polystyrene-reduced molecular weight of 1,000,000 (GPC measured gel), and the weight average molecular weight of a component detected after the elution time corresponding to the polystyrene-reduced molecular weight of 1,000,000 (hereinafter called “component (X)”) of the resulting copolymer latex were determined by GPC measurement. The GPC measured gel content and the weight average molecular weight were determined using the above-described methods.

The toluene insoluble content of the resulting copolymer latex was determined using the above-described method.

The particle diameter of the copolymer latex was measured using a particle diameter measurement system (“LPA-3100” manufactured by Otsuka Electronics Co., Ltd.). The results are shown in Table 2.

(Preparation of Paper Coating Composition)

Paper coating compositions for offset printing were prepared using the copolymer latexes obtained in Examples 1 and 2 according to the following formulation.

(Formulation)

Kaolin clay: 70.0 parts

Calcium carbonate: 30.0 parts

Dispersant: 0.2 part

Sodium hydroxide: 0.1 part

Starch: 4.0 parts

Latex (solid content): 10.0 parts

Water was added in an appropriate amount so that the total solid content was 60%.

The paper coating composition was applied to one side of paper using a motor-driven blade coater (manufactured by Kumagaya Riki Kogyo K.K.) so that the amount applied was 13.0±0.5 g. The applied composition was dried at 150° C. for 15 seconds using an electric hot-blast dryer. The resulting coated paper was allowed to stand in a thermo-hygrostat at a temperature of 23° C. and a humidity of 50% for twenty-four hours, and subjected to four occurrences of supercalendering under conditions of a line pressure of 100 kg/cm and a roll temperature of 50° C. The performance of the resulting coated paper was evaluated according to the following methods.

(1) Dry Pick Resistance

The degree of picking at the time of printing using an RI printing tester was judged by naked-eye observation and classified into five grades. The less the degree of picking phenomenon, the higher the grade. The values were average values of six measurements.

(2) Wet Pick Resistance

After wetting the surface of the coated paper using a water feed roll, the degree of picking at the time of printing using an RI printing tester was judged by naked-eye observation and classified into five grades. The less the degree of picking phenomenon, the higher the grade. The values were average values of six measurements.

(3) Print Gloss

Offset ink was applied over all the surface of the coated paper using an RI printing tester. Print gloss was measured at an incident angle of 60° using a Murakami-type glossimeter.

(4) Latex Redispersibility

The latex was applied to black woolen cloth paper using a No. 18 rod. After drying the latex at room temperature for one minute, the black woolen cloth paper was immediately washed with hot water at 40° C. for three minutes. After drying the black woolen cloth paper at room temperature, the amount of latex film remaining on the black woolen cloth paper was classified into five grades. The smaller the amount of the remaining latex film, the higher the grade. The values were average values of three measurements.

(5) Anti-Stick Properties

The latex was applied to a polyethyleneterephthalate film using a No. 18 rod. The latex was dried at 120° C. for 30 seconds to form a latex film. The latex film was caused to adhere to black woolen cloth paper by bench supercalendering under conditions of a line pressure of 200 kg/m and a humidity of 70° C. After removing the latex film from the black woolen cloth paper, the amount of the black woolen cloth paper transferred to the latex was judged by naked eye observation and classified into five grades. The less the amount of transfer, the higher the grade. The values were average values of six measurements.

(6) Mechanical Stability

Mechanical shear was applied to the copolymer latex (solid content: 30 wt %, sample: 120 g) using a commercially-available Maron mechanical stability tester under conditions of a rotor rotation rate of 1,000 rpm, rotor load of 15 kg, and rotation time of 15 minutes. Aggregates remaining on 120-mesh wire gauze was collected. After drying the collected aggregates, the ratio of the aggregates to the solid content in the sample was determined by wt %.

(7) Missing Dot Rate (Index of Gravure Printability)

The coated paper was gravure printed using a gravure printability tester (manufactured by Kumagaya Riki Kogyo K.K.) at a printing rate of 100 m/min. and a line pressure of 20 kg/cm using “DIC gravure ink OG104 Red” (manufactured by Dainippon Ink and Chemicals, Inc.), which was diluted with toluene so that the flow rate was nine seconds using a Zahn cup No. 3. The missing dot rate was measured by observing the occurrence of missing dots. The smaller the missing dot rate, the better the gravure printability.

(8) Calender Roll Stain Resistance

An aluminum sheet was placed on the surface of the coated paper before supercalendering. The coated paper was supercalendered at a roll temperature of 60° C. and a line pressure of 250 kg/cm. After removing the aluminum sheet from the coated paper, the degree of staining of the aluminum sheet was indicated by a gloss decrease rate (%). The smaller the gloss decrease rate, the smaller the degree of staining.

The evaluation results using these evaluation methods are shown in Table 2.

### Examples 3-6

A high-pressure reaction vessel equipped with a stirrer and thermostat was charged with a first-stage component shown in Table 1. After replacing the atmosphere of the polymerization system with nitrogen, the polymerization system was heated to 50° C. A second-stage component shown in Table 1 and one-third of a reducing agent aqueous solution were continuously added to the polymerization system for three hours. A third-stage component shown in Table 1 and one-third of the reducing agent aqueous solution were continuously added to the polymerization system for three hours. The remaining one-third of the reducing agent aqueous solution was continuously added for five hours to complete the polymerization. The final polymer conversion rate was 98%.

The resulting copolymer latex was subjected to pH adjustment and concentration using the same methods as in Examples 1 and 2.

The average particle diameter, toluene insoluble content, GPC measured gel content (%), and weight average molecular weight of the component (X) of the copolymer latex were measured using the same methods as in Examples 1 and 2. The particle diameter of the copolymer latex was measured using the same method as in Examples 1 and 2. The results are shown in Table 2.

In Examples 3 and 4, preparation of a paper coating composition for offset printing, preparation of coated paper, and evaluation of the performance of the coated paper were performed using the same methods as in Examples 1 and 2. In Examples 5 and 6, a paper coating composition for gravure printing was prepared according to the following formulation.

(Formulation)

Kaolin clay: 100.0 parts

Dispersant: 0.2 part

Sodium hydroxide: 0.1 part

Starch: 1.0 part

Latex (solid content): 7.0 parts

Water was added in an appropriate amount so that the total solid content was 60%.

These compositions were adjusted to 9.0 pH by adding an appropriate amount of a sodium hydroxide aqueous solution. The resulting compositions were applied to one side of coat cardboard of 54 g/m² using a motor-driven blade coater so that the amount applied was 13±0.5 g/m². The resulting coated paper was allowed to stand in a room at a temperature of 20° C. and a relative humidity of 65% for twenty-four hours, and subjected to four occurrences of supercalendering under conditions of a roll temperature of 50° C. and a line pressure of 200 kg/m². The coated paper was subjected to the above tests.

The dry pick resistance, missing dot rate, and calender roll stain resistance of the resulting coated paper were evaluated.

The evaluation results of the resulting paper coating compositions are shown in Table 2.

### Example 7

A paper coating composition was prepared using the copolymer latex obtained in Example 1 in the same manner as in Example 1 except for using 60.0 parts of kaolin clay and 10.0 parts of hollow polymer particles as pigments. The evaluation results are shown in Table 2.

TABLE 1

| Component | Example | | | | | |
|---|---|---|---|---|---|---|
| (part) | 1 | 2 | 3 | 4 | 5 | 6 |
| (First-stage | | | | | | |
| component) | | | | | | |
| Water | 100 | 100 | 100 | 100 | 100 | 100 |
| Sodium | 0.3 | 0.6 | 0.3 | 0.3 | 0.1 | 0.1 |
| dodecyl- | | | | | | |
| benzene- | | | | | | |
| sulfonate | | | | | | |
| Potassium | 1 | 1 | 1 | 1 | 1 | 1 |
| persulfate | | | | | | |
| Ferrous sulfate | 0.005 | 0.005 | 0.004 | 0.004 | 0.004 | 0.004 |
| heptahydrate | | | | | | |
| Butadiene | 5 | 5 | | | | |
| Styrene | 2 | | | | | |
| Acrilonitrile | 2 | 2 | | | | |
| Acrylic acid | | | 1 | 2 | 0.2 | 0.3 |
| Itaconic acid | 0.5 | | 1 | | 0.3 | 0.2 |
| α- | | 0.1 | | | | |
| Methylstyrene | | | | | | |
| dimer | | | | | | |
| t-Dodecyl- | 0.3 | 0.4 | | | | |
| mercaptan | | | | | | |
| (Second-stage | | | | | | |
| component) | | | | | | |
| Butadiene | 35 | 30 | 20 | 28 | 40 | 35 |
| Styrene | 25 | 45 | 21 | 17 | 17 | 16.5 |
| Acrilonitrile | 9 | 5 | 5 | 10 | 9 | 5 |
| Methyl | 20 | 10 | 10 | | | 7 |
| methacrylate | | | | | | |
| Acrylic acid | 1 | 1.5 | 0.5 | | 2 | 1 |
| Itaconic acid | 0.5 | 1.5 | 0.5 | | 1 | 2 |
| α- | 0.4 | 0.2 | 0.3 | 0.3 | 0.5 | 0.5 |
| Methylstyrene | | | | | | |
| dimer | | | | | | |
| t-Dodecylmer- | 0.4 | 0.2 | 0.2 | 0.3 | 0.3 | 0.4 |
| captan | | | | | | |
| (Reducing | | | | | | |
| agent aqueous | | | | | | |
| solution) | | | | | | |
| Water | 10 | 10 | 10 | 10 | 10 | 10 |
| Rongalite | | 0.4 | | | | 0.4 |
| Sodium | 0.3 | | 0.3 | 0.3 | 0.3 | |
| hydrogensulfite | | | | | | |
| Sodium | 0.2 | | | | 0.1 | 0.1 |
| dodecyl- | | | | | | |
| benzene- | | | | | | |
| sulfonate | | | | | | |
| (Third-stage | | | | | | |
| component) | | | | | | |
| Butadiene | | | 15 | 12 | 10 | 20 |
| Styrene | | | 22 | 26 | 11 | 7 |
| Acrilonitrile | | | 4 | | 4 | 2 |
| Methyl | | | | 5 | 5 | 4 |
| methacrylate | | | | | | |
| Itaconic acid | | | | | 0.5 | |
| α- | | | | 0.5 | 0.5 | 0.3 |
| Methylstyrene | | | | | | |
| dimer | | | | | | |
| t-Dodecylmer- | | | 0.1 | 0.3 | 0.1 | 0.1 |
| captan | | | | | | |

TABLE 2

| | Example | | | | | | |
|---|---|---|---|---|---|---|---|
| | 1 | 2 | 3 | 4 | 5 | 6 | 7 |
| (Property of copolymer latex) | | | | | | | |
| Particle diameter (nm) | 115 | 125 | 120 | 110 | 140 | 150 | 115 |
| GPC measure gel content (%) | 62 | 58 | 71 | 80 | 78 | 84 | 62 |
| Weight average molecular | 90,000 | 100,000 | 80,000 | 70,000 | 80,000 | 70,000 | 90,000 |
| weight of component (X) | | | | | | | |
| Toluene insoluble content (%) | 73 | 63 | 84 | 88 | 85 | 89 | 73 |
| Mechanical stability (%) | 0.003 | 0.005 | 0.003 | 0.001 | 0.001 | 0.001 | 0.003 |
| (Evaluation of property of | | | | | | | |
| paper coating composition) | | | | | | | |
| Dry pick resistance | 4.6 | 4.1 | 4.7 | 4.8 | 4.9 | 4.9 | 4.6 |
| Wet pick resistance | 4.4 | 4.2 | 4.2 | 4.5 | — | — | 4.5 |
| Print gloss (%) | 83.6 | 81.6 | 86.0 | 85.0 | — | — | 87.6 |
| Anti-stick property | 4.5 | 4.7 | 4.8 | 4.5 | — | — | 4.5 |
| Latex redispersibility | 4.6 | 4.8 | 4.8 | 4.6 | — | — | 4.6 |
| Missing dot rate (%) | — | — | — | — | 3 | 1.5 | — |
| Calender roll stain resistance | — | — | — | — | 4.5 | 4.2 | — |

### Comparative Example 1

A high-pressure reaction vessel equipped with a stirrer and thermostat was charged with a first-stage component shown in Table 3. After replacing the atmosphere of the polymerization system with nitrogen, the polymerization system was heated to 40° C. The monomers were then polymerized for one hour. A second-stage component shown in Table 3 and half of an initiator aqueous solution were continuously added to the polymerization system for seven hours. After increasing the polymerization temperature to 85° C., the remaining half of the initiator aqueous solution was continuously added for four hours to complete the polymerization. The final polymer conversion rate was 98%.

The resulting copolymer latex was subjected to pH adjustment and concentration using the same methods as in Examples 1 and 2.

The average particle diameter, toluene insoluble content, GPC measured gel content (%), and weight average molecular weight of the component (X) of the copolymer latex were measured using the same methods as in Examples 1 and 2. The particle diameter of the copolymer latex was measured using the same method as in Examples 1 and 2.

In Comparative Example 1, preparation of a paper coating composition for offset printing, preparation of coated paper, and evaluation of the performance of the coated paper were performed using the same methods as in Examples 1 and 2. The results are shown in Table 4.

### Comparative Examples 2-4

A high-pressure reaction vessel equipped with a stirrer and thermostat was charged with first-stage components shown in Table 3. After replacing the atmosphere of the polymerization system with nitrogen, the polymerization system was heated to 50° C. A second-stage component shown in Table 3 and one-third of an initiator aqueous solution were continuously added to the polymerization system for five hours. A third-stage component shown in Table 3 and one-third of the initiator aqueous solution were continuously added to the polymerization system for five hours. The remaining one-third of the initiator aqueous solution was continuously added for five hours to complete the polymerization. The final polymer conversion rate was 98%.

The resulting copolymer latex was subjected to pH adjustment and concentration using the same methods as in Examples 1 and 2.

The average particle diameter, toluene insoluble content, GPC measured gel content (%), and weight average molecular weight of the component (X) of the copolymer latex were measured using the same method as in Examples 1 and 2. The particle diameter of the copolymer latex was measured using the same method as in Examples 1 and 2. The results are shown in Table 4.

TABLE 3

| | Comparative Example | | | |
|---|---|---|---|---|
| Component (part) | 1 | 2 | 3 | 4 |
| (First-stage component) | | | | |
| Water | 100 | 100 | 100 | 100 |
| Sodium | 0.3 | 0.3 | 0.3 | 0.1 |
| dodecylbenzenesulfonate | | | | |
| Potassium persulfate | 1 | 1 | 1 | 1 |
| Ferrous sulfate | 0.005 | 0.004 | 0.004 | 0.004 |
| heptahydrate | | | | |
| Butadiene | 5 | | | |
| Styrene | 2 | | | |
| Acrilonitrile | 2 | | | |
| Acrylic acid | | 1 | 2 | 0.3 |
| Itaconic acid | 0.5 | 1 | | 0.2 |
| t-Dodecylmercaptan | 0.3 | | | |
| (Second-stage | | | | |
| component) | | | | |
| Butadiene | 35 | 20 | 28 | 35 |
| Styrene | 25 | 21 | 17 | 16.5 |
| Acrilonitrile | 9 | 5 | 10 | 5 |
| Methyl methacrylate | 20 | 10 | | 7 |
| Acrylic acid | 1 | 0.5 | | 1 |
| Itaconic acid | 0.5 | 0.5 | | 2 |
| α-Methylstyrene dimer | 0.6 | 0.7 | 0.3 | 0.1 |
| t-Dodecylmercaptan | 0.7 | 0.7 | 0.3 | 0.1 |
| (Initiator aqueous | | | | |
| solution) | | | | |
| Water | 10 | 10 | 10 | 10 |
| Sodium persulfate | 0.3 | 0.3 | 0.3 | 0.4 |
| (Third-stage component) | | | | |
| Butadiene | | 15 | 12 | 20 |
| Styrene | | 22 | 26 | 7 |
| Acrilonitrile | | 4 | | 2 |
| Methyl methacrylate | | | 5 | 4 |
| α-Methylstyrene dimer | | 0.7 | 0.5 | |
| t-Dodecylmercaptan | | 0.5 | 0.3 | 0.1 |

TABLE 4

| | Comparative Example | | | |
|---|---|---|---|---|
| | 1 | 2 | 3 | 4 |
| (Property of copolymer latex) | | | | |
| Particle diameter (nm) | 118 | 123 | 106 | 155 |
| GPC measure gel content (%) | 62 | 27 | 80 | 95 |
| Weight average molecular weight | 27,000 | 40,000 | 25,000 | 27,000 |
| of component (X) | | | | |
| Toluene insoluble content (%) | 68.4 | 28.0 | 83.7 | 95.1 |
| Mechanical stability (%) | 0.098 | 0.120 | 0.040 | 0.010 |
| (Evaluation of property of paper | | | | |
| coating composition) | | | | |
| Dry pick resistance | 3.7 | 2.4 | 3.8 | 2.4 |
| Wet pick resistance | 4.4 | 3.1 | 2.5 | — |
| Print gloss (%) | 80.1 | 78.0 | 85.0 | — |
| Anti-stick property | 3.6 | 2.6 | 3.7 | — |
| Latex redispersibility | 2.8 | 1.5 | 3.5 | — |
| Missing dot rate (%) | — | — | — | 30 |
| Calender roll stain resistance | — | — | — | 6 |

In Comparative Examples 2 and 3, preparation of a paper coating composition for offset printing, preparation of coated paper, and evaluation of the performance of the coated paper were performed using the same methods as in Examples 1 and 2. In Comparative Example 4, preparation of a paper coating composition for gravure printing, preparation of coated paper, and evaluation of the performance of the coated paper were performed using the same methods as in Examples 5 and 6. The results are shown in Table 4.

The copolymer latexes and the paper coating composition using the copolymer latexes obtained in Examples 1-7 are according to the present invention. As is clear from the results shown in Table 2, in the copolymer latex of the present invention, the content of a component detected before the elution time corresponding to the polystyrene-reduced molecular weight of 1,000,000 (GPC measured gel) in a molecular-weight distribution measured by gel permeation chromatography (GPC) was 31% or more, the weight average molecular weight of a component detected after the elution time corresponding to the polystyrene-reduced molecular weight of 1,000,000 was 30,000-400,000, and the toluene insoluble content was 31 wt % or more. Therefore, in the case of using the copolymer latex for a paper coating binder, the paper coating binder exhibits high bond strength due to the possession of superior resistance to an extremely large degree of deformation during high-speed printing. Moreover, print gloss, anti-stick properties, mechanical stability, and redispersibility are excellent.

In Comparative Examples 1 and 3, dry pick resistance, anti-stick properties, and mechanical stability were inferior since the weight average molecular weight of the copolymer latex was less than the specified range. In Comparative Example 2, dry pick resistance, wet pick resistance, mechanical stability, and anti-stick properties were inferior since the GPC measured gel content and the toluene insoluble content of the copolymer latex were less than the specified range. In Comparative Example 4, the missing dot rate and dry pick resistance were inferior since the weight average molecular weight of the copolymer latex was less than the specified range.

### Examples 8-11

(Production Process of Copolymer Latex)

A high-pressure reaction vessel equipped with a stirrer and thermostat was charged with a first-stage component shown in Table 5. The atmosphere of the polymerization system was replaced with nitrogen. After heating the polymerization system to 45° C., the monomers were polymerized for one hour to obtain a polymer (P). After confirming that the polymer conversion rate had reached 70% or more, a second-stage component and one-third of a reducing agent aqueous solution were continuously added to the polymerization system for three hours. Then, a third-stage component and one-third of the reducing agent aqueous solution were continuously added to the polymerization system for three hours. The remaining one-third of the reducing agent aqueous solution was continuously added for three hours to complete the polymerization. The final polymer conversion rate was 99%.

The resulting copolymer latex was subjected to pH adjustment and concentration using the same methods as in Examples 1 and 2. The average particle diameter, weight average molecular weight of the component (X), etc. were measured using the same methods as in Examples 1 and 2. In Examples 10 and 11, the pH was adjusted using potassium hydroxide.

In Table 5, the total amount of the monomers in the first-stage component corresponds to the monomer component (A) of the present invention, and the sum of the total amount of the monomers in the second-stage component and the total amount of the monomers in the third-stage component corresponds to the monomer component (B) of the present invention.

(Preparation of Paper Coating Composition)

Preparation of a paper coating composition for offset printing, preparation of coated paper, and evaluation of the performance of the coated paper were performed using the copolymer latexes obtained in Examples 8-11 using the same methods as in Examples 1 and 2. The results are shown in Table 6.

### Examples 12 and 13

A high-pressure reaction vessel equipped with a stirrer and thermostat was charged with a first-stage component shown in Table 5. The atmosphere of the polymerization system was replaced with nitrogen. After heating the polymerization system to 45° C., the monomers were polymerized for one hour to obtain a polymer (P). After confirming that the polymer conversion rate had reached 70% or more, a second-stage component and one-fourth of a reducing agent aqueous solution were added to the polymerization system all at once. After confirming that the polymer conversion rate of the first-stage component and the second-stage component reached 70% or more, a third-stage component and one-half of the reducing agent aqueous solution were continuously added to the polymerization system for two hours. The remaining one-fourth of the reducing agent aqueous solution was continuously added for three hours to complete the polymerization. The final polymer conversion rate was 98%.

The resulting copolymer latex was subjected to pH adjustment and concentration using the same methods as in Examples 1 and 2. The average particle diameter, weight average molecular weight of the component (X), etc. were measured using the same methods as in Examples 1 and 2. The results are shown in Table 6.

In Examples 12 and 13, preparation of a paper coating composition for gravure printing, preparation of coated paper, and evaluation of the performance of the coated paper were performed using the same methods as in Examples 5 and 6. The results are shown in Table 6.

TABLE 5

| Component | Example | | | | | |
|---|---|---|---|---|---|---|
| (part) | 8 | 9 | 10 | 11 | 12 | 13 |
| (First-stage | | | | | | |
| component) | | | | | | |
| Water | 120 | 120 | 120 | 120 | 120 | 120 |
| Sodium | 0.6 | 0.6 | 0.4 | 0.3 | 0.15 | 0.15 |
| dodecyl- | | | | | | |
| benzene- | | | | | | |
| sulfonate | | | | | | |
| Potassium | 1 | 1 | 1 | 1 | 1 | 1 |
| persulfate | | | | | | |
| Ferrous | 0.005 | 0.005 | 0.004 | 0.004 | 0.004 | 0.004 |
| sulfate | | | | | | |
| heptahydrate | | | | | | |
| Butadiene | 20 | 7 | 35.5 | 24 | 15 | 12 |
| Styrene | | 3 | | 16 | 4.5 | 3 |
| Acrilonitrile | 10 | 3 | 15 | 8 | 5 | 3 |
| Methyl | | 2 | | | | |
| methacrylate | | | | | | |
| Acrylic acid | | | 1 | 1 | 0.5 | |
| Itaconic acid | | | 0.5 | | | |
| α- | 0.1 | | 0.1 | 0.3 | 0.1 | |
| Methylstyrene | | | | | | |
| dimer | | | | | | |
| t-Dodecylmer | 0.3 | 0.3 | 0.2 | 0.1 | 0.1 | 0.1 |
| captan | | | | | | |
| Total amount | 30 | 15 | 52 | 49 | 25 | 18 |
| of monomer | | | | | | |
| component (A) | | | | | | |
| (Second-stage | | | | | | |
| component) | | | | | | |
| Butadiene | 10 | 30 | 5 | 6 | 21 | 20 |
| Styrene | 13.5 | 5 | 11 | 5 | 5 | 16.5 |
| Acrilonitrile | 9 | 5 | 5 | 4 | 9 | 5 |
| Methyl | 10 | 15 | 2 | 7 | | 2 |
| methacrylate | | | | | | |
| Acrylic acid | 2.5 | 1.5 | 1 | 2.5 | 2 | 1.5 |
| Itaconic acid | 1 | 1.5 | | | 1 | 2 |
| α- | 0.4 | 0.4 | 0.1 | 0.3 | 0.3 | 0.3 |
| Methylstyrene | | | | | | |
| dimer | | | | | | |
| t-Dodecylmer- | 0.4 | 0.2 | 0.1 | 0.1 | 0.2 | 0.2 |
| captan | | | | | | |
| (Reducing | | | | | | |
| agent aqueous | | | | | | |
| solution) | | | | | | |
| Water | 10 | 10 | 10 | 10 | 10 | 10 |
| Rongalite | | 0.4 | | | | 0.4 |
| Sodium | 0.3 | | 0.3 | 0.3 | 0.3 | |
| hydrogen- | | | | | | |
| sulfite | | | | | | |
| (Third-stage | | | | | | |
| component) | | | | | | |
| Butadiene | 10 | 8 | 4.5 | 7.5 | 22 | 20 |
| Styrene | 10 | 12 | 12 | 6 | 7 | 6 |
| Acrilonitrile | 4 | 2 | 4 | 4 | 2.5 | 2 |
| Methyl | | 5 | 3 | 8 | 5 | 7 |
| methacrylate | | | | | | |
| Itaconic acid | | | 0.5 | 1 | 0.5 | |
| α- | | 0.5 | 0.2 | 0.3 | 0.3 | 0.2 |
| Methlstyrene | | | | | | |
| dimer | | | | | | |
| t-Dodecylmer- | 0.1 | 0.2 | 0.3 | 0.1 | 0.1 | 0.1 |
| captan | | | | | | |
| Total amount | 70 | 85 | 48 | 51 | 75 | 82 |
| of monomer | | | | | | |
| component (B) | | | | | | |

TABLE 6

| | Example | | | | | |
|---|---|---|---|---|---|---|
| | 8 | 9 | 10 | 11 | 12 | 13 |
| (Property of polymer (P)) | | | | | | |
| Tg (° C.) | −39 | −8 | −44 | −60 | −40 | −50 |
| (Property of copolymer latex) | | | | | | |
| Particle diameter (nm) | 108 | 114 | 120 | 132 | 150 | 155 |
| Weight average molecular weight of | 95,000 | 90,000 | 85,000 | 110,000 | 75,000 | 80,000 |
| component (X) | | | | | | |
| GPC measure gel content (%) | 50 | 60 | 63 | 46 | 74 | 71 |
| Toluene insoluble content (%) | 82 | 85 | 88 | 80 | 90 | 89 |
| Mechanical stability (%) | 0.003 | 0.001 | 0.005 | 0.005 | 0.001 | 0.001 |
| (Evaluation of property of paper | | | | | | |
| coating composition) | | | | | | |
| Dry pick resistance | 4.2 | 4.2 | 4.5 | 4.8 | 4.9 | 4.9 |
| Wet pick resistance | 4.4 | 4.7 | 4.2 | 4.5 | — | — |
| Print gloss (%) | 83.6 | 81.6 | 86.0 | 85.0 | — | — |
| Anti-stick property | 4.5 | 4.7 | 4.8 | 4.5 | — | — |
| Latex redispersibility | 4.7 | 4.5 | 4.9 | 4.5 | — | — |
| Missing dot rate (%) | — | — | — | — | 3 | 1.5 |
| Calender roll stain resistance | — | — | — | — | 4.5 | 4.2 |

### Comparative Examples 5-7

A high-pressure reaction vessel equipped with a stirrer and thermostat was charged with a first-stage component shown in Table 7. The atmosphere of the polymerization system was replaced with nitrogen. After heating the temperature inside the reaction vessel of the polymerization system to 50° C., the monomers were polymerized for one hour. A second-stage component and one-third of an initiator aqueous solution were continuously added to the polymerization system for seven hours. Then, a third-stage component and one-third of the initiator aqueous solution were continuously added to the polymerization system for three hours. After increasing the polymerization temperature to 75° C., the remaining one-third of the initiator aqueous solution was continuously added for four hours to complete the polymerization. The final polymer conversion rate was 99%.

The resulting copolymer latex was treated and evaluated in the same manner as in Examples 1 and 2.

In Comparative Examples 5 and 6, a paper coating composition for offset printing was prepared and the performance thereof was evaluated. In Comparative Example 7, a paper coating composition for gravure printing was prepared and the performance thereof was evaluated. The results are shown in Table 8.

The copolymer latexes and the paper coating compositions in Examples 8-13 are copolymer latexes obtained by the production process of the present invention and paper coating compositions using the copolymer latexes. As is clear from the results shown in Table 6, the copolymer latex of the present invention exhibited high bond strength because the weight average molecular weight of a component detected after the elution time corresponding to the polystyrene-reduced molecular weight of 1,000,000 in the molecular-weight distribution measured by GPC was 30,000-400,000. Moreover, print gloss, anti-stick properties, mechanical stability, and redispersibility were excellent.

In Comparative examples 5 and 6, dry pick resistance, anti-stick properties, and mechanical stability were inferior since the weight average molecular weight of the copolymer latex was less than the specified range. In Comparative Example 7, the missing dot rate and dry pick resistance were inferior since the weight average molecular weight of the copolymer latex was less than the specified range.

TABLE 7

| | Comparative Example | | |
|---|---|---|---|
| Component (part) | 5 | 6 | 7 |
| (First-stage component) | | | |
| Water | 120 | 120 | 120 |
| Sodium | 0.6 | 0.4 | 0.15 |
| dodecylbenzenesulfonate | | | |
| Potassium persulfate | 1 | 1 | 1 |
| Ferrous sulfate heptahydrate | 0.005 | 0.004 | 0.004 |
| Butadiene | 2 | | 3 |
| Styrene | 18 | 5 | 12 |
| Acrilonitrile | 5 | 15 | |
| Methyl methacrylate | | | 3 |
| Acrylic acid | | | 1 |
| Itaconic acid | | 0.5 | 1 |
| α-Methylstyrene dimer | 0.1 | 0.1 | |
| t-Dodecylmercaptan | 0.3 | 0.2 | 0.1 |
| Total amount of monomer | 25 | 20.5 | 20 |
| component (A) | | | |
| (Second-stage component) | | | |
| Butadiene | 20 | 13 | 30 |
| Styrene | 10 | 21 | 11.5 |
| Acrilonitrile | 7 | 5 | 5 |
| Methyl methacrylate | 6 | 10 | 2 |
| Acrylic acid | 2 | 1.5 | 0.5 |
| Itaconic acid | 1 | 2 | 1 |
| α-Methylstyrene dimer | 0.4 | 0.7 | 0.3 |
| t-Dodecylmercaptan | 0.4 | 0.1 | 0.2 |
| (Initiator aqueous solution) | | | |
| Water | 10 | 10 | 10 |
| Sodium persulfate | 0.3 | 0.3 | 0.3 |
| (Third-stage component) | | | |
| Butadiene | 15 | 15 | 20 |
| Styrene | 10 | 8 | 5 |
| Acrilonitrile | 4 | 4 | 2 |
| Methyl methacrylate | | | 3 |
| α-Methylstyrene dimer | | | 0.2 |
| t-Dodecylmercaptan | 0.1 | 0.1 | 0.1 |
| Total amount of monomer | 75 | 79.5 | 80 |
| component (B) | | | |

TABLE 8

| | Comparative Example | | |
|---|---|---|---|
| | 5 | 6 | 7 |
| (Property of polymer (P)) | | | |
| Tg (° C.) | 60 | 110 | 35 |
| (Property of copolymer latex) | | | |
| Particle diameter (nm) | 118 | 114 | 154 |
| Weight average molecular weight of | 25,000 | 26,000 | 26,000 |
| component (X) | | | |
| GPC measure gel content (%) | 50 | 72 | 76 |
| Toluene insoluble content (%) | 71 | 88 | 90 |
| Mechanical stability (%) | 0.087 | 0.120 | 0.050 |
| (Evaluation of property of paper | | | |
| coating composition) | | | |
| Dry pick resistance | 2.9 | 1.5 | 3.6 |
| Wet pick resistance | 3.1 | 3.3 | — |
| Print gloss (%) | 79.1 | 74.6 | — |
| Anti-stick property | 2.6 | 3.9 | — |
| Latex redispersibility | 2.5 | 3.5 | — |
| Missing dot rate (%) | — | — | 44 |
| Calender roll stain resistance | — | — | 3.4 |

As described above, the copolymer latex of the present invention and the paper coating composition using the copolymer latex excel in bond strength, redispersibility, print gloss, and anti-stick properties. Moreover, the copolymer latex and the paper coating composition exhibit improved mechanical stability and excel in coating operability, printing workability, and printability. Therefore, the copolymer latex and the paper coating composition are extremely valuable for industrial applications.

Obviously, numerous modifications and variations of the present invention are possible in light of the above teachings. It is therefore to be understood that, within the scope of the appended claims, the invention may be practiced otherwise than as specifically described herein.

What is claimed is:

1. A copolymer latex produced by emulsion polymerization of (a) 10-80 parts by weight of a conjugated diene monomer, (b) 0.01-15 parts by weight of an ethylenically unsaturated carboxylic acid monomer, and (c) 5-89.99 parts by weight of other monomers copolymerizable with the conjugated diene monomer (a) and the ethylenically unsaturated carboxylic acid monomer (b), provided that the total amount of the components (a), (b), and (c) is 100 parts by weight,
wherein, in a molecular weight distribution measured by gel permeation chromatography (GPC), components detected after an elution time at which a component having a polystyrene-reduced molecular weight of 1,000,000 is detected have a weight average molecular weight of 30,000-400,000.

2. The copolymer latex according to claim 1, wherein, in the molecular weight distribution measured by GPC, the content of components detected before the elution time at which the component having a polystyrene-reduced molecular weight of 1,000,000 is detected is 31% or more.

3. The copolymer latex according to claim 1, wherein, in the molecular weight distribution measured by GPC, the content of components detected before the elution time at which the component having a polystyrene-reduced molecular weight of 1,000,000 is detected is 35-90%.

4. The copolymer latex according to claim 1, wherein the toluene insoluble content is 31 wt % or more.

5. The copolymer latex according to claim 1, wherein the toluene insoluble content is 51-95 wt %.

6. The copolymer latex according to claim 1, wherein the components detected after the elution time at which the component having a polystyrene-reduced molecular weight of 1,000,000 is detected have a weight average molecular weight of 40,000-200,000.

7. The copolymer latex according to claim 1, wherein the component (c) comprises a vinyl cyanide monomer.

8. A process for producing a copolymer latex comprising: emulsion polymerizing (a) 10-80 parts by weight of a conjugated diene monomer, (b) 0.01-15 parts by weight of an ethylenically unsaturated carboxylic acid monomer, and (c) 5-89.99 parts by weight of other monomers copolymerizable with the conjugated diene monomer (a) and the ethylenically unsaturated carboxylic acid monomer (b), provided that the total amount of the components (a), (b), and (c) is 100 parts by weight, in the presence of a polymerization initiator comprising a radical catalyst and a reducing agent.

9. The process for producing a copolymer latex according to claim 8, wherein the polymerization initiator further comprises an oxidation-reduction catalyst.

10. The process for producing a copolymer latex according to claim 8, wherein at least part of the reducing agent is added batchwise and/or continuously during the polymerization step of the monomers.

11. A process for producing a copolymer latex comprising:
emulsion polymerizing 5-80 parts by weight of (A) a monomer component comprising (a) 20-99 wt % of a conjugated diene monomer, (b) 0-10 wt % of an ethylenically unsaturated carboxylic acid monomer, and (c) 0-80 wt % of other copolymerizable monomers to prepare a polymer (P) having a glass transition temperature (Tg) of 0° C. or less, and
emulsion polymerizing 20-95 parts by weight of (B) a monomer component comprising (a) 0-80 wt % of a conjugated diene monomer, (b) 0.01-20 wt % of an ethylenically unsaturated carboxylic acid monomer, and (c) 0-99.99 wt % of other copolymerizable monomers, provided that the total amount of the monomer components (A) and (B) is 100 parts by weight, in the presence of the polymer (P) and a polymerization initiator comprising a radical catalyst and a reducing agent,
wherein at least part of the reducing agent is added batchwise and/or continuously at least during the polymerization step of the monomer component (B), and
wherein the total amount of the conjugated diene monomer (a), ethylenically unsaturated carboxylic acid monomer (b), and other copolymerizable monomers (c) in the monomer components (A) and (B) is 10-80 wt %, 0.01-15 wt %, and 5-89.99 wt %, respectively.

12. The process for producing a copolymer latex according to claim 11, wherein the polymerization initiator further comprises an oxidation-reduction catalyst.

13. The process for producing a copolymer latex according to claim 11, wherein the emulsion polymerization is carried out at a temperature of 5-60° C.

14. The process for producing a copolymer latex according to claim 11, wherein the component (c) in the monomer component (A) comprises 0.1-50 wt % of a vinyl cyanide monomer.

15. The process for producing a copolymer latex according to claim 11, wherein the component (c) in the monomer component (B) comprises 0.1-30 wt % of a vinyl cyanide monomer.

16. A paper coating composition comprising the copolymer latex of claim 1 and a pigment.

17. A paper coating composition comprising a copolymer latex obtained using the process of claim 11 and a pigment.

18. The paper coating composition according to claim 15 or 16, comprising hollow polymer particles as at least part of the pigment.

19. The paper coating composition according to claim 15 or 16, which is used for offset printing.

20. The paper coating composition according to claim 15 or 16, which is used for gravure printing.
